(19) United States
(12) Patent Application Publication
(10) Pub. No.: US 2015/0024624 A1
(43) Pub. Date: Jan. 22, 2015

(54) Connector housing assembly

(71) Applicant: William Monagle, Orange, CA (US)

(72) Inventor: William Monagle, Orange, CA (US)

(73) Assignee: Pacific Power Source

(21) Appl. No.: 13/987,402

(22) Filed: Jul. 22, 2013

(51) Int. Cl. H01R 13/58

(52) U.S. Cl. CPC H01R 13/5841
USPC 439/534

(57) ABSTRACT

A connector housing assembly for use with an electrical device and a cable having a connector is disclosed. In one embodiment, the assembly has a body, a cable access element, and an attachment assembly. The housing is connected to the electrical device by the attachment assembly. The cable connector attaches to the electrical device and resides within the connector housing assembly. The cable extends from the connector through the cable access element and outward in a desired direction. Movement of the cable outside of the connector housing assembly transfers a portion of the force to the body of the connector housing thereby reducing the strain on the connection between the connector and the electrical device.

### FIELD OF THE INVENTION

This invention generally relates to housings for an electrical cable connector.

### BACKGROUND OF THE INVENTION

Electronic devices such as AC and DC Power Supplies are in common use and often critical in the operation of other electrical devices. Cables and connectors are routinely connected to the front and back panels of these power supplies and other electrical devices. Often, a power supply or other electrical device may be situated on a bench or within a cabinet or rack. In these configurations it is possible for the cables connected to the panels to abut objects such a cabinet frames or table tops thereby placing stress on the connection point with the device.

This stress can damage the cable connector, the wires, and the complementary equipment mating attachment. Various undesirable results could include equipment failure resulting from damage to the connector pins, or incomplete connections between the connector and the mating elements resulting in the inaccurate transmission of power and information.

While it may appear that one solution would be to move the cable around obstructions, this is not always an acceptable solution. When a cable is bent the cable can transfer stress to the connection joint nevertheless.

What is needed is an apparatus that protects the cable connector when connected to electrical equipment, directs the cable from interacting with structures, and reduces the stress placed on the connector.

### SUMMARY OF THE INVENTION

In accordance with the present disclosure, a connecting housing assembly for use with electrical equipment is provided. In one embodiment, the connector housing assembly attaches to an electrical device and houses the connector end of an electrical cable that is also connected to the electrical device. The housing assembly directs the cable in a desired direction.

The connector housing assembly has a body portion to house the electrical cable connector and the body portion is capable of attaching to the electrical device. There is also a cable access element having an opening to receive the cable and hold it securely. The cable access element is capable of attaching to the body in a plurality of positions and each position provides a different location for the opening in regard to the body.

In operation, the cable access element is attached to the body portion such that the opening in the cable access element is in a desired location in regard to the body and the body is attached to the electrical device with the cable connector within the body while the cable attached to the connector passes through the cable access element opening thereby directing the cable in a desired direction.

### BRIEF DESCRIPTION OF THE DRAWINGS

The invention is generally shown by way of reference to the accompanying drawings in which:

FIG. 1 is a perspective view of a cable having a connector for attaching to an electrical device;

FIG. 2 is a perspective view of a back panel of an electrical device having a receptor for the cable connector;

FIG. 3 is a perspective view of a cable access element having an opening;

FIG. 4 is a perspective view of the cable access element with the opening oriented in a different direction;

FIG. 5 is a perspective view of the body of the cable housing assembly;

FIG. 6 is a cross sectional view of the attachment element;

FIG. 7 is a perspective view of the body, cable access element, and attachment element assembled;

FIG. 8 is another perspective view of the assembled cable housing assembly;

FIG. 9 is a perspective view of the cable housing assembly attached to the back panel of an electrical device;

FIG. 10 is a cutaway perspective view of an alternate cable exit configuration of the cable connector;

FIG. 11 is a perspective view of a cable housing assembly where the opening can be rotated;

FIG. 12 is a perspective view of an embodiment of the cable housing assembly with a cable access element in a first of three possible positions;

FIG. 13 is a perspective view of an embodiment of the cable housing assembly with a cable access element in a second of three possible positions; and

FIG. 14 is a perspective view of an embodiment of the cable housing assembly with a cable access element in a third of three possible positions.

### DETAILED DESCRIPTION OF THE INVENTION

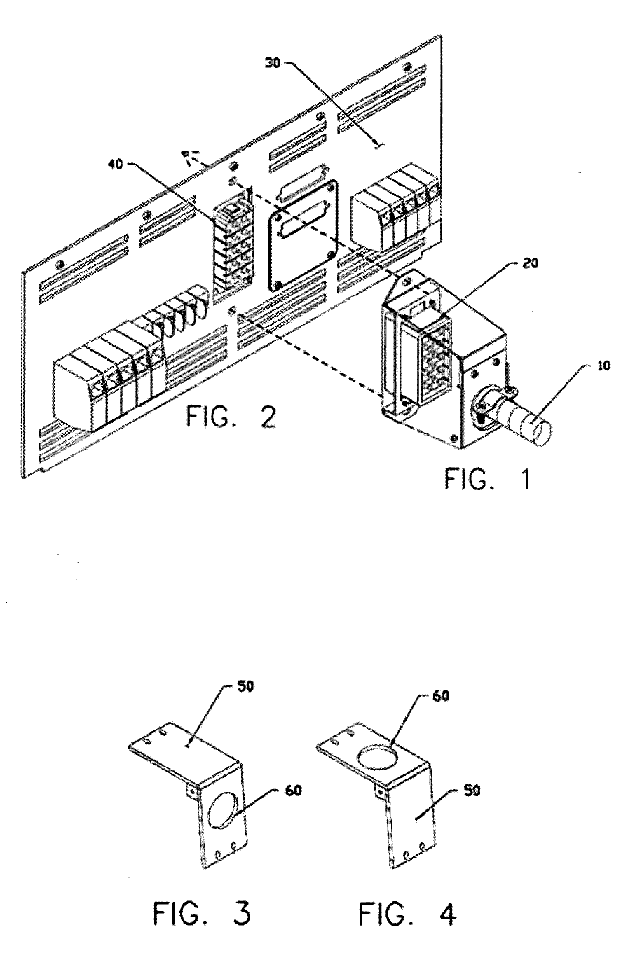

FIG. 1 shows a cable 10 and connector 20 and FIG. 2 identifies an electrical device back panel 30 with a corresponding receiving structure 40. In operation for this particular configuration, the cable connector 20 would mate with the corresponding structure 40 on the back panel 30. This is typically a male and female pin connection arrangement.

FIG. 3 is an embodiment of the cable access element 50 of the cable housing assembly. The cable access element 50 in this embodiment has an opening 60 to receive the cable and act as device for a strain relief. As identified in FIG. 4, the cable access element 50 has two positions in this embodiment, depending on the location of the opening 60 that can direct the cable. The cable access element 50 can include materials circling the opening such as, but not limited to, rubber that can function to reduce abrasion to the cable and to provide a tighter fit to the cable. In this manner the amount of movement experienced by the connector due to movement of the cable is reduced thereby further reducing strain on the connector.

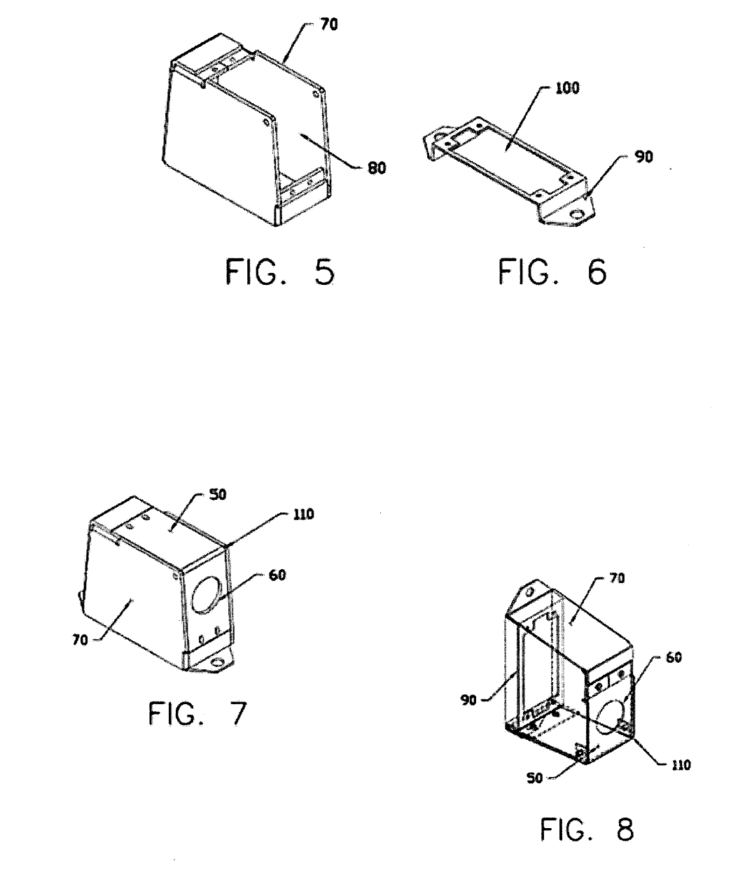

FIG. 5 depicts the body 70 of the cable housing assembly. The body 70 can be adapted to house a variety of different types of cable connections. Further, in other embodiments the body can substantially house the cable connector. In yet another embodiment, the body may be more skeletal in nature where the connector may or may not be entirely covered by the body.

In the present embodiment, the body 70 has an opening 80 to receive the cable access element 50. FIG. 6 identifies an attachment assembly 90 that attaches the body 70 to an electrical device. Well known techniques including the use of screws or welding as examples can be employed to secure the attachment assembly 90 to the body 70. In other embodiments, the attachment assembly could be integral to the body instead of a separate structure as in the identified embodiment. In another embodiment, the attachment assembly 90 may also function to retain the cable connector in place. In such a case, the cable housing assembly and the cable connector 20 act as a single unit for purposes of attaching the cable connector to an electrical device.

Turning to FIG. 7, the connector housing assembly 110 in this embodiment contains the body 70, cable access element 50, and attachment assembly 90. It is apparent that the opening 60 of the cable access element 50 could be in one of two possible locations depending upon the orientation of the cable access element 50 in relation to the body 70. This allows the user to determine the optimal positioning of the cable in a particular application to reduce strain on the connection.

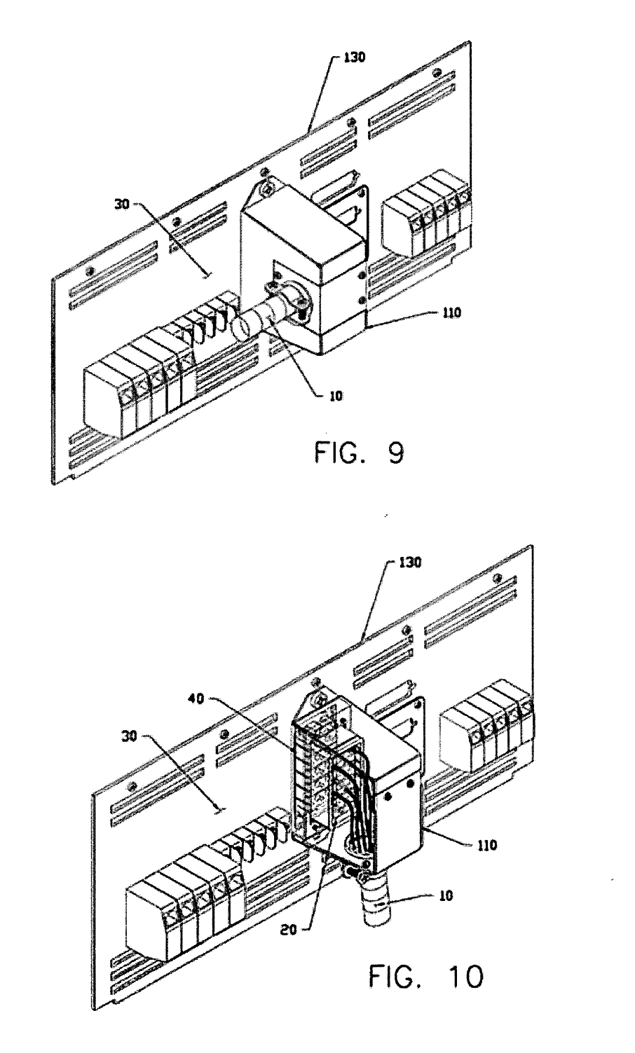

The completed connector housing assembly 110 is positioned in FIG. 8 to attach to an electrical device. In FIG. 9 the connector housing assembly 110 is attached to the back plate 30 of an electrical device 130 and the cable 10 is relatively secured in a desired direction. Attachment of the connector housing assembly 110 to the body can be accomplished in a number of ways including the use of screws. The cutaway view in FIG. 10 shows how the cable connection 20 mates with a corresponding structure 40 of the electrical device.

The movement of the cable outside of the connector housing assembly directs forces on the cable 10 to the cable access element 50 and therefore the body 70 of the connector housing assembly 110 thereby reducing strain on the connection between the connector 20 and the mating element 40. The cable access element 50 and body 70 act together with the cable 10 to provide a measure of stress relief for the connections and assist in keeping the connector 20 and mating element 40 in alignment.

As identified in FIG. 11, in another embodiment the cable access element 50 can include a movable portion 140 that can vary the location of the opening 60 in relation to the body 70 after the cable access element 50 is secured to the body 70. In this fashion the opening can be varied in relation to the body without removing and repositioning the cable access element. When the desired location is found, then the movable portion 140 can be secured in place. In other embodiments the opening can be positioned in a more circular fashion such as related to a ball bearing type structure having a hole for the cable and the structure capable of positioning the opening at various angles in relation to the body.

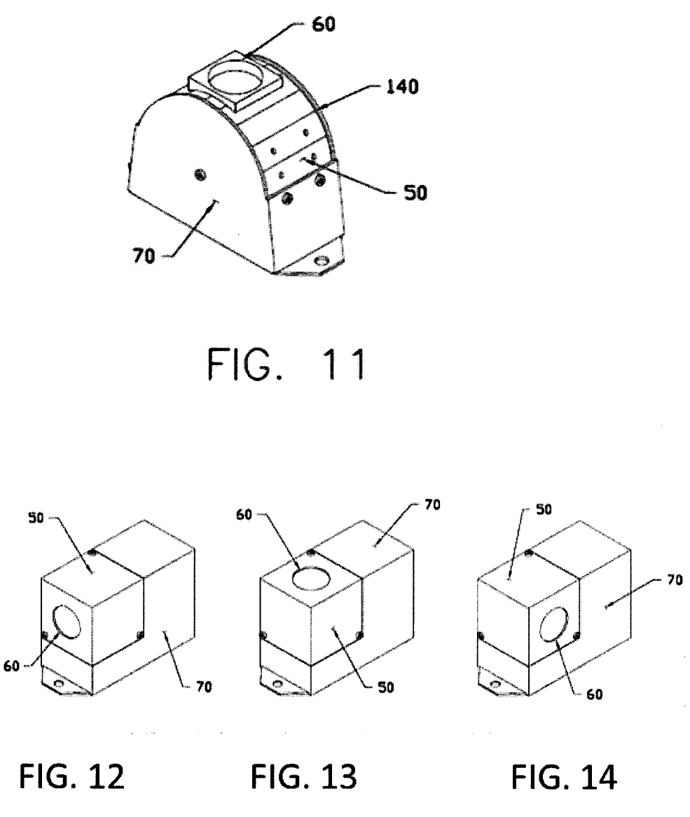

FIG. 12 is another embodiment of the cable housing assembly where the access element 50 can be positioned in one of three possible locations in regards to the body 70 thereby allowing the opening 60 to be in one of three locations. FIG. 13 shows the cable access element 50 positioned such that the opening is in a second location. FIG. 14 identifies the cable access element 50 positioned such that the opening is in a third location relative to the body 70.

While embodiments have been described in detail, it should be appreciated that various modifications and/or variations may be made without departing from the scope or spirit of the invention. In this regard it is important to note that practicing the invention is not limited to the applications described herein. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein. Thus, it is intended that the invention cover all such embodiments and variations. Nothing in this disclosure is intended to limit the scope of the invention in any way.

What is claimed is:

1. A connector housing assembly for attaching to an electrical device and housing the connector end of an electrical cable that is connected to the electrical device and to direct the cable in a desired direction, the assembly comprising:
a body portion adapted to house the electrical cable connector and the body portion capable of attaching to the electrical device;
a cable access element having an opening to receive the cable and the cable access element capable of attaching to the body in a plurality of positions and each position providing a different location for the opening in regard to the body; and
the cable access element being attached to the body;
wherein the body being attached to the electrical device with the cable connector connected to the electrical device and the cable connector disposed within the body while the cable attached to the connector passes through the cable access element opening thereby directing the cable in a desired direction.

2. A connector housing assembly for attaching to an electrical device and housing the connector end of an electrical cable that is connected to the electrical device and to direct the cable in a desired direction, the assembly comprising:
a body portion to house the electrical cable connector and the body portion capable of attaching to the electrical device; and
a cable access element attached to the body and having an opening to receive the cable and the cable access element movable to provide a desired location of the opening in regard to the body;
wherein the body is attached to the electrical device with the cable connector connected to the electrical device and the cable connector within the body while the cable attached to the connector passes through the cable access element opening and the direction of the opening thereby directing the cable in a desired direction.

3. A connector housing assembly for attaching to an electrical device and housing the connector end of an electrical cable that is connected to the electrical device and to direct the cable in a desired direction, the assembly comprising:
a body portion adapted to substantially house the electrical cable connector and the body portion capable of attaching to the electrical device;
a cable access element having an opening to receive the cable and the cable access element capable of attaching to the body in a plurality of positions and each position providing a different location for the opening in regard to the body; and
the cable access element being attached to the body;
wherein the body being attached to the electrical device with the cable connector connected to the electrical device and the cable connector disposed within the body while the cable attached to the connector passes through the cable access element opening thereby directing the cable in a desired direction.

4. A connector housing assembly for attaching to an electrical device and housing the connector end of an electrical cable that is connected to the electrical device and to direct the cable in a desired direction, the assembly comprising:
a body portion adapted to substantially house the electrical cable connector and the body portion capable of attaching to the electrical device;
a cable access having a movable portion to vary the location of an opening in relation to the body; and
the cable access element being attached to the body;
wherein the body being attached to the electrical device with the cable connector connected to the electrical device and the cable connector disposed within the body while the cable attached to the connector passes through the cable access element opening thereby directing the cable in a desired direction.
